(19) United States
(12) Patent Application Publication
(10) Pub. No.: US 2010/0241289 A1
(43) Pub. Date: Sep. 23, 2010

(54) Method and apparatus for path planning, selection, and visualization

(76) Inventor: Roy Sandberg, San Francisco, CA (US)

Correspondence Address: Roy Sandberg, 1822 McAllister St # 7, San Francisco, CA, 94115, US

(21) Appl. No.: 12/308,611

(22) PCT Filed: Jul. 21, 2007
(86) PCT No.: PCT/US2007/014489

§ 371 Date: Dec. 18, 2008

Related U.S. Application Data
(60) Provisional application No. 60/815,897, filed on Jun. 22, 2006.

(51) Int. Cl. G06F 7/00; G01C 21/00

(52) U.S. Cl. 701/2; 701/301

(57) ABSTRACT

New and Improved methods and apparatus for robotic path planning, selection, and visualization are described A path spline visually represents the current trajectory of the robot through a three dimensional space such as a room By altering a graphical representation of the trajectory—the path spline—an operator can visualize the path the robot will take, and is freed from real-time control of the robot Control of the robot is accomplished by periodically updating the path spline such that the newly updated spline represents the new desired path for the robot Also a sensor that may be located on the robot senses the presence of boundaries (obstacles) in the current environment and generates a path that circumnavigates the boundaries while still maintaining motion in the general direction selected by the operator The mathematical form of the path that circumnavigates the boundaries may be a spline

### BACKGROUND OF THE INVENTION

(1) Field of Invention

The present invention is related to the field of robotics, more specifically, the invention is method and system for interactive robotic path planning, path selection, and path visualization.

(2) Related Art

A significant pool of research has been devoted to the problem of robotic path planning—the problem of allowing an autonomous robot to navigate its way through an unfamiliar environment. However, unique problems arise when, instead of an autonomous robot, a human is controlling a remote controlled surrogate presence (henceforth referred to as a Mobile Video Teleconferencing Device, or “MVTD”).

In USPTO application 20010037163 (Allard), and U.S. Pat. Nos. 6,535,793 (Allard) and 6,845,297 (Allard) a method is discussed for remote control of a mobile robot which requires the operator to select a target to move towards by means of a waypoint. This imposes a number of limitations. For example, a target must be selected, which is limiting when a definite target is not known. On the fly assignment of new movements is difficult. Also, the orientation of the robot at any particular location along its travel path can not be readily discerned by the user.

### SUMMARY OF THE INVENTION

The present invention is a new and improved method and apparatus for robotic path planning, selection, and visualization.

This patent application incorporates by reference copending application Ser. No. 11/223,675 (Sandberg). Matter essential to the understanding of the present application is contained therein.

In one embodiment of the invention, a path spline visually represents the current trajectory of the robot through a three dimensional space such as a room. By altering a graphical representation of the trajectory—the path spline—an operator can visualize the path the robot will take, and is freed from real-time control of the robot. Control of the robot is accomplished by periodically updating the path spline such that the newly updated spline represents the new desired path for the robot. This method does not require computationally expensive algorithms to recognize objects in the visual space, and the motion-path of the robot can be updated while the robot is still moving, resulting in a time-efficient movement scheme that does not suffer from the time lag effects or real-time interaction of traditional joystick-based control.

In another embodiment of the invention, a sensor located on the robot senses the presence of boundaries (obstacles) in the current environment, and generates a path that circumnavigates the boundaries, while still maintaining motion in the general direction selected by the operator. The mathematical form of the path that circumnavigates the boundaries may be a spline. This frees the operator from planning out complex move sequences while still allowing the operator to visualize and correct for improper automated path generation. Furthermore any operator error resulting from selecting a path that nearly intersects or intersects an obstruction is gracefully corrected.

In another embodiment of the invention, the visual representation of the robot's environment is modified to represent its location at the time the visual representation is displayed for a remote user, based on an analysis of the robots present speed and direction and an estimate of the time-of-flight for information over the telecommunications data link being used. This modification of the visual representation may consist of digitally zooming in by an amount equal to the calculated future forward motion of the robot, and digitally panning left, right, up, or down based on the calculated future forward angular velocity of the robot. In addition, objects moving in the robots field of view, may also be placed in their calculated future position using feature detection techniques known in the art of computer vision. This allows the operator to plan new move sequences on-the-fly based on a simulation of the current conditions the robot is encountering. Therefore the operator can respond more quickly and can move the device at a higher velocity, resulting in more efficient tele-operation.

In another embodiment of the invention, the device corrects for errors in its movement path due to wheel slip by comparing its actual position with the position predicted by wheel position sensors. The invention allows an operator to pan and tilt the device's camera while this error correction is occurring without impacting the accuracy of the movement path correction.

In another embodiment of the invention, the device automatically displays suggested paths to the user when likely paths are detected, simplifying the process of navigating the device through a space. The suggested paths are displayed as splines or other lines superimposed on the image of the space through which the device is moving.

### DETAILED DESCRIPTION OF THE DRAWINGS

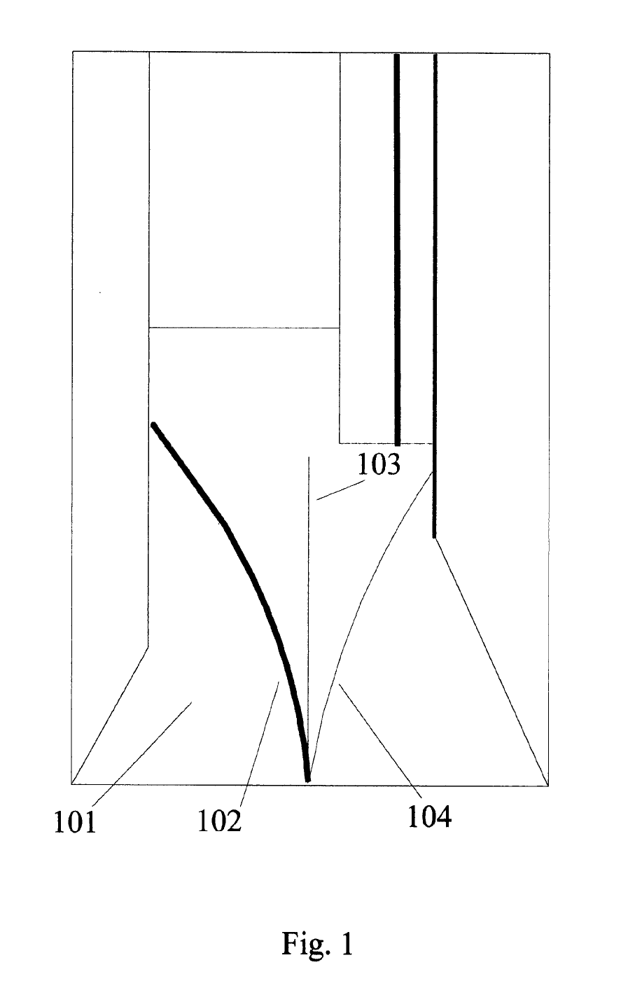

FIG. 1 is a exemplary embodiment of the invention displaying a path spline to the operator.

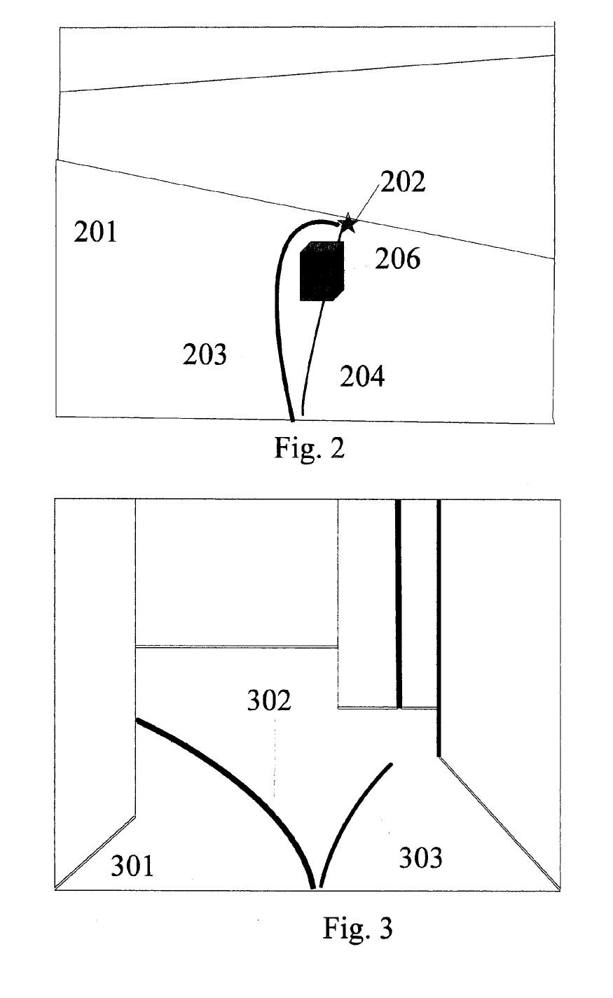

FIG. 2 is a exemplary embodiment of the invention's obstacle avoidance functionality.

FIG. 3 is a exemplary embodiment of the path suggestion feature.

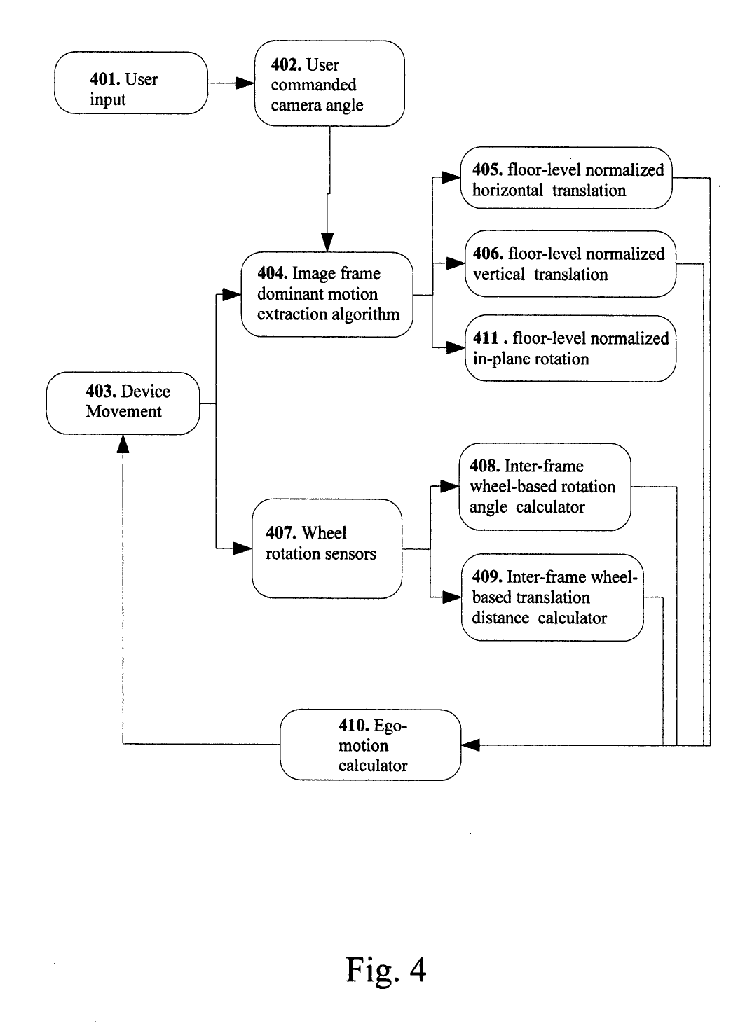

FIG. 4 is a diagram illustrating dead-reckoning correction functionality.

### DETAILED DESCRIPTION OF THE INVENTION

The present invention is a new and improved method and apparatus for robotic path planning, selection, and visualization.

### Path-Planning Image Superposition

FIG. 1 is a exemplary embodiment of the invention displaying a path spline to the operator. An image of a hallway is shown to an operator 101. The operator can control a path spline 102 by using a user interface to twist it, in this case to the left. User interface techniques known in the art can control the orientation of the path spline. Alternative path splines are also shown. A straight path 103 occurs when the spline is not curved. The spline can also be made to curve to the right 104. A remotely controlled robot is programmed to move in accordance with the path the spline curve maps onto the floor. In an alternative embodiment, the path taken by the robot may be displayed as a straight line from the robot's current location to a desired destination. In yet another embodiment, the path taken by the robot is composed of a series of segments that taken together form a continuous function defining a path from the robot's current location to all locations through which the robot is to move. For example, a path composed of a clothoid spiral, followed by a continuous curve, followed by another clothoid spiral, and finishing with a straight line segment can be used to represent a move at a constant velocity through a series of points in a Cartesian plane.

Because the distance from the camera to the floor, the angle of the camera with the floor, and the field of view of the camera are all known, it is possible to compute the motion path dictated by a path spline when superimposed on a substantially flat and level floor surface. In other words, a visualization of a path superimposed on a video image can be translated into an actual move through the real world. If the angle of the robot relative to the horizon is also known, then the floor surface need not be level. The trajectory of the robot can be computed by mathematically transforming the camera image such that the floor is transformed from a foreshortened view to a bird's eye view. Define a Cartesian space such that the viewing axis of the camera is the x-axis, the left-right axis is the y-axis, and the up-down axis is the z-axis. The origin of this space is the point on the floor located in the center of the camera's field of view. Call the angle of the camera relative to pointing straight at the floor (in the x-z plane) “β.” A bird's eye view of the floor can then be created by rotating about the y-axis by β. This can be accomplished by using a matrix of the form:

$${R}_{y} ( β ) = [ \begin{matrix}cos β & 0 & - sin β & 0 \\ 0 & 1 & 0 & 0 \\ sin β & 0 & cos β & 0 \\ 0 & 0 & 0 & 1\end{matrix} ]$$

In an alternative embodiment, the path spline is rotated via this transformation, such that a path across a Cartesian plane is mapped onto the visual surface. The path will thus be foreshortened in accordance with the rules of perspective rendering.

Once the image or path spline is rotated in this manner towards the viewer, the distance along the floor surface as represented in the transformation is proportional to distances as they actually appear.

With knowledge of the height and viewing angle of the camera, the distance from the camera to the point around which the image or spline was rotated can be calculated. Assuming a camera height of h above the floor, and a camera angle of β as defined above, the distance along the camera axis (the x-axis) to the origin (“d”) would be:

d=h/cos(β)

This equation works when β<90; for other angles the camera axis would never intersect the plane defining the floor.

The real-world coordinate of any point in the transformed image or spline can now be computed in the plane of the image (the h,v plane) as follows:

realₕ=(2d*tan(0.5 FOVₕ)/Pixelsₕ)*Imageₕ

realᵥ=(2d*tan(0.5 FOVᵥ)/Pixelsᵥ)*Imageᵥ

where FOVₕ is the field-of-view of the camera along the camera's horizontal axis, FOVᵥ is the field-of-view of the camera along the camera's vertical axis, Pixelsₕ is the pixel count along the horizontal axis, and Pixelsᵥ is the pixel count along the vertical axis. Imageₕ and Imageᵥ are the horizontal and vertical coordinates in pixels and realₕ and realᵥ are the horizontal and vertical coordinates in the real world.

In the preferred embodiment of the invention, the movement spline is updated as the camera tilt angle changes so that the movement spline is always properly superimposed on the image sent by the camera.

A superimposed path suggestion can be displayed to a user both while the device is standing still and while it is moving. If the device is moving, path suggestions must be contained to only those paths that are physically possible at the time the move is desired. In this case, the path must be precomputed based on known environmental and robot characteristics, and this precomputed path must be transformed into a perspective corrected path that is then superimposed on the display surface as discussed above.

The path suggestions are constrained by physical limitations of the robot. In particular, a non-holonomic differential drive robot can only move in the direction it is facing, or backwards away from the direction it is facing, with an instantaneous motion vector that is tangent to the arc circumscribed by the current motion direction. Furthermore, wheel speed can not change instantaneously, and therefore only path suggestions that enable non-instantaneous wheel speed changes are valid. When the device is standing still, it can be made to turn in place, or turn at an arbitrary radius. However, when the device is moving, continuous wheel speed changes result in the robot traversing an arc of constantly varying radius. In the preferred embodiment, the wheel speed changes at a constant linear rate, limited by some maximal acceleration and deceleration. This linear change in wheel speed results in a path of travel that takes the form of a spiral. In particular, a spiral known as a clothoid describes a path with a linearly changing radius with respect to angle.

Various equations, shown below, can be used to compute the path that describes the motion of a device along a clothoid spiral.

Given a linearly constant differential change in wheel speed Accel_{diff}, a constant velocity Vel, and a distance between drive wheels W, the instantaneous turn radius of a differential drive robot at time t is:

Rₜ=R₀+W(Vel/2*Accel_{diff}*t) (1)

The rate of change of angle of the robot can be expressed as:

theta=Vel/R (2)

and thus the angular velocity at a time t is:

thetaᵥ=(2*Accel_{diff}*t)/W (3)

integrating this equation to get angular position at time t gives:

thetaₚ=theta₀+(Accel_{diff}*t²)/W (4)

Velocity in the Cartesian plane can be described by:

Vx=Vel*sin(thetaₚ)=v*sin(theta₀+(Accel_{diff}*t²)/W) (5)

Vy=Vel*cos(thetaₚ)=v*cos(theta₀+(Accel_{diff}*t²)/W) (6)

Integrating this equation gives the device's position in the (x,y) plane at time t. An integral of the form sin(t̂2) and cos(t̂2) is known as a Fresnel integral, and can be evaluated using the series expansion form:

$$S ( x ) = {\int }_{0}^{x} sin ( {t}^{2} ) d t = {\sum }_{n = 0}^{∞} {( - 1 )}^{n} \frac{{x}^{4 n + 3}}{( 4 n + 3 ) ( 2 n + 1 ) !}$$

$$and$$

$$C ( x ) = {\int }_{0}^{x} cos ( {t}^{2} ) d t = {\sum }_{n = 0}^{∞} {( - 1 )}^{n} \frac{{x}^{4 n + 1}}{( 4 n + 1 ) ( 2 n ) !}$$

Alternatively, integration by parts may be used to derive an (x,y) coordinate. The solution to this integral will be:

Dx=integral(Vel*sin(thetaₚ))

Dy=integral(Vel*cos(thetaₚ))

In the preferred embodiment, a path given a current position and velocity is generated from the current location to a final location. A turn from a current location to a new location can be expressed as a translation (x,y) in a Cartesian plane as well as a rotation (theta) in this plane. Therefore an algorithm for determining a path from a starting location (0,0,0) to a final location (x,y,theta), and reducing this path to a series of robot movement commands is required. In the preferred embodiment, the following technique is used. A minimum turn radius is selected based on the device's current speed. The faster the device is moving, the larger the radius of the turn must be, so that the device does not loose traction due to the lateral acceleration imposed by the turn. Given this turning radius, a path can be composed of a series of four segments:
1) Starting Transition Clothoid (x1,y1,theta1)
2) Minimum Turn Radius Arc (x2,y2,theta2)
3) Ending Transition Clothoid (x3,y3,theta3)
4) Line Segment (x4,y4,0)

where (x1+x2+x3+x4)=x, (y1+y2+y3+y4)=y, and (theta1+theta2+theta3)=theta.

It should be noted that some (x,y,theta) positions are not possible due to the velocity of the device at the time the segment is requested. In particular, if

theta1+theta3>theta (9)

then the device can not turn fast enough to accommodate the move. Also, if:

(x1+x3>x) OR (y1+y3>y) (10)

then the device can not circumscribe a turn in the desired distance.

Given a starting radius R0, and a Minimum Turn Radius Arc R1, theta1 can be found by equation (4), x1 can be found by equation (7) and y2 can be found by equation (8). Similarly, given that the line segment has a radius (R3) of infinity, x3, y3, and theta3 can be found by similar formulaic substitution. Assuming equation (9) is satisfied, (x2,y2,theta2) are calculated by:

theta2=theta−(theta1+theta3) (11)

x2=sin(theta2)−R1 (12)

y2=cos(theta2) (13)

Finally, assuming equation (10) is satisfied, the line segment is equal to:

x4=x−(x1+x2+x3) (14)

y4=y−(y1+y2+y3) (15)

Using this technique, a path from any starting coordinate to any end coordinate and angle, consistent with the constraints discussed, can be superimposed on the display surface, using the techniques discussed above for superimposing paths on a visual field.

In the preferred embodiment, a differential drive robot is programmed to follow each of the path segments discussed above.

Straight paths can be followed by turning both drive wheels at the identical speed. Curved paths of a continuous radius can be followed by turning one wheel at a fixed multiple of the other wheel's speed. For a desired radius and wheel velocity, the difference in speed between the two wheels, Vdiff is:

Vdiff=(Width*Velocity)/(2*Radius)

where Width is the distance between the drive wheels, Velocity is the velocity of the robot, and Radius is the radius of the turn to be completed. Finally, clothoid spiral transitions can be followed by linearly accelerating both drive wheels in opposite directions, as shown in equation (1).

Techniques known in the art, such as motors with distance sensors, driven with a power level controlled by a proportional integral controller, where the proportional integral controller uses feedback from the distance sensors, may be used to control the wheels. By specifying distances that comport with the distances expected at discrete time intervals from the above techniques, the device can be made to smoothly follow the desired paths.

In the preferred embodiment, a user interface superimposes possible paths based on the above technique onto the video screen, using techniques discussed above. Paths that are not physically possible (for example, as determined by equations 9 and 10), will not be displayed. In an alternative embodiment, a valid path nearest to an physically impossible path is displayed to the user, thereby only enabling the user to select legal paths. A path nearest to the physically impossible path can be calculated by selecting a (theta, x, y) triplet that balances both sides of equations 9 and 10.

In the preferred embodiment, the path spline is controlled with a computer mouse or other pointing device. By clicking the mouse on a location on the local video image of the remote location, the robot is made to move towards that real world location using the techniques discussed above. In an alternative embodiment, the user interface sends new path splines defining a path to the location selected by the mouse at a set rate while the mouse button is depressed. In other words, subsequent move sequences are continuously and automatically executing by the robot at a predefined rate. In the preferred embodiment, four path splines are sent every second, but any update rate can be used. When the mouse button is released, a command to stop robot movement is sent, aborting the currently active motion sequence. This alternative embodiment advantageously treats a lack of user input as a command to stop motion. This is an intuitive result—a user may wish to stop robot motion when letting go of the mouse. Additionally, this embodiment conveys a sense of active control of the robot speed through the path spline length. A longer path spline length results in a higher top speed because the maximum velocity of the robot is dictated by the distance that is left to travel.

### Obstacle Avoidance

FIG. 2 is a exemplary embodiment of the invention displaying its obstacle avoidance functionality. A view of an environment as seen by an MVTD is shown 201. An MVTD operator desires to move the MVTD to a destination 202. The direct path to the destination 204, is blocked by an obstacle 206. The MVTD automatically deviates from the requested direct path 204, and takes a new path 203 which avoids the obstacle.

An MVTD operates in an environment filled with stationary and dynamic obstacles. A means of allowing the operator to control the device while at the same time enabling the device to avoid obstacles is useful. However, an operator can become confused if the device moves in a manner different than what was commanded. By displaying deviations in its course due to obstacles as a superimposed image on the video display, the operator is given immediate feedback of course corrections, and can better plan subsequent move sequences. Using techniques known in the art to detect obstacles, such as sonar, light beams, IR sensors, or optical flow algorithms, the device acquires knowledge of obstacles blocking its path. In the preferred embodiment, the GP2DXX line of Sharp™ IR detectors are used. At least two IR sensors returning a distance measurement from an obstacle are used, the sensors arranged to point forwards toward the direction of device movement.

If any sensor detects an obstacle closer than a specified distance, an imminent collision can be assumed, and using techniques known in the art of computer programming and motion control, the robot can be made to decelerate at a rate that prevents a collision with the obstacle(s). Specifically, a minimum distance required to stop in time to avoid hitting an obstacle can be calculated, and the IR sensors can trigger deceleration whenever an obstacle is found at a distance close to this threshold. The following equation can be used to calculate this threshold distance:

minimumDistanceRequiredToStop=v²/2a

where v is the current velocity, and a is the deceleration rate.

In an alternative embodiment, a plot of obstacle distance with respect to viewing angle over some field of view is used. This data may be acquired with a rotating laser scanner. When computationally processing the data, local minima located in front of the device represent obstacles that are in danger of being hit by the device.

The device may be programmed to avoid a detected obstacle once a threat of collision is imminent. In the preferred embodiment, device turns in the direction that is known to have a local maxima. In the preferred embodiment, turning is accomplished by slowing the speed of the drive wheel most distance from the obstacle.

In alternative embodiments, one wheel can be sped up and the other slowed down such that the overall device speed is kept constant. In another alternative embodiment, the wheel closer to the obstacle can be sped up in order to induce a turn away from the obstacle. The local maxima, above, can be the largest distance reading if a number of individual sensors are used, or it can be the largest distance value detected with the rotating laser scanner or similar distance-with-respect-to-angle data source. In an alternative embodiment, the distance-with-respect-to-angle data is computationally low-pass filtered to eliminate spurious data points. Deviation from the original requested path due to the turning induced by obstacle detection is displayed such that the modified path is shown in addition to the original path. In an alternative embodiment, the device determines whether an obstacle in front of the robot is moving using techniques known in the art, and reacts by slowing down to match the speed of the moving obstacle (presumed to be people who are moving in front of it).

In another alternative embodiment, in addition to deviating from the path as necessary to avoid to obstacle, the device reduces its speed in proportion to the total distance to the obstacle. This prevents the device from hitting obstacles, and also reduces movement speeds for tight maneuvers. This feature also provides easier entrance and egress through doorways due to the additional reaction time the lower speed affords the user.

In another alternative embodiment, three distance sensors are used to avoid obstacles. For example, infra-red range finders may be mounted in 20 degree horizontal increments, centered around the front of the robot. When the center range-finder detects an approaching obstacle, the device can be made to turn towards the direction that has the largest open distance, as detected by the left and right range-finders. In another embodiment, if all three sensors detect an obstacle (presumably of great width, such as a wall) and the object is moving substantially tangent to this obstacle, then the obstacle avoidance feature is disabled, as it can be inferred by the course of the robot that the operator intends to direct the robot towards the obstacle. In yet another embodiment, a virtual bumper is created by fusing data together from multiple sensors accumulated over time, the virtual bumper representing a predefined area directly in front of the robot. Only objects that appear in front of the virtual bumper are avoided.

### Narrow Maneuvering

The delay between issuing a movement command to the MVTD and seeing the results of the movement makes accurately moving the MVD difficult. This difficulty is exacerbated in narrow confines where a movement error of only a few inches can result in the MVTD impacting an object. Hallways and doorways are particularly problematic. Distance data from at least two distance sensors positioned around the body of the MVTD can be used to keep the position of the MVTD equidistant from the two edges of the doorway or hallway when the distances between the distance sensors and the doorway fall below a specified threshold. This can be implemented by a computer program running on the MVTD that decreases the wheel speed of the wheel on the side farthest from the doorway or hallway wall, while increasing the wheel speed of the wheel on the side nearest to the doorway or hallway wall. In this way the controlling user is freed from managing the small-scale maneuvering of the device and can control the device more easily. The suggested path course set by the user is used for course-grain control of the MVTD, while the dynamic path correction by the sensors corrects for fine-grain maneuvering around minor obstacles without user intervention.

### Path Suggestion

FIG. 3 is a exemplary embodiment of the path suggestion feature. The MVTD camera displays a view of a typical office hallway 301. By gaging the distance of objects with respect to the MVTD, it is possible to algorithmically derive a likely path leading to the end of the hallway 302 as well as an alternative likely path leading to a door 303. These paths may be displayed as images superimposed on the camera's view. In this way, a user can select a likely path merely by clicking on the suggested path. In the preferred embodiment, likely paths are displayed using an alternative color or line pattern (i.e., dashed, dotted, etc.) than the color or line pattern used to represent the device's current path and the user-defined path.

By using techniques known in the art to determine the distance of objects with respect to the MVTD (for example optical flow, laser scanners, IR sensors, or sonar), likely paths can be displayed to the user, simplifying the task of driving the MVTD through an environment. Specifically, viewing a plot of distance with respect to viewing angle over some field of view, local maxima represent likely paths in an environment. These paths (or some subset of them, for example the tallest three maxima) can be displayed on the current image of the environment using techniques discussed above. In one implementation, when a user clicks on one of the suggested paths, it is selected as the new path for the robot to follow. In another implementation, the path with the largest maxima is automatically selected if the user does not intervene before some set time frame.

In another embodiment, distance data is gathered as above. Using this information doorways can be distinguished from walls by finding local maximum in the angle vs. distance function. Using an assumption that the doorway is located in a straight wall, the angle of the MVTD relative to the wall with the door can be calculated. The angle of the wall can be taken into account when calculating the suggested path so that the MVTD will end up perpendicular to the wall when it enters the doorway. This eases navigation as the MVTD will be facing directly down the hallway (if one exists) which connects to the door.

In another implementation, a spline is drawn from the current location of the MVTD to the user's mouse pointer. The user can modify this potential trajectory by moving the mouse location. When the user moves the mouse near an area that matches a suggested path (as described above) the path changes color, gets larger, stays in place, or presents some other visual cue to indicate that the user has selected a path which matches with the suggestions calculated from the distance sensor. This makes selection of the suggested path easier, because the mouse “snaps to” the suggested path.

### Predictive Visualization

Assuming a 200 ms round-trip delay in video transmission, an MVTD moving at 1 meter per second would move 20 cm before a user command to alter it's trajectory could take effect. This raises some issues with controlling the device, particularly at moderate to high movement rates. By displaying a representation of where the unit will be, rather than where it is, a user can more effectively control the device. Because the device can not instantaneously change position, predictive visualization is not subject to discontinuities from one frame to the next. Predictive visualization can be used to correct for both forward velocity as well as turning rate. Three time frames are relevant when discussing transmission-based delay when using an MVTD. T0 is the time when a new command is issued by a user. At time T1 the command reaches the MVTD and is processed. At time T2, the MVTD world view at the time the command was processed is visible to the user.

Two embodiments of predictive visualization will be discussed. The preferred embodiment, image-flow based predictive visualization, depends on low-error image flow data to predict a future representation of the image. This technique is preferred because it predicts both rotation and translation based movement. Occlusion of certain predictive image data may occur with this method because translation-based prediction inherently carries the possibility of occlusions. A second embodiment of the invention is image-centering based scaling. This method does not use optical flow, but rather, computes how the entirety of the image moves from frame to frame. This corrects only for rotation-based movement and not translation, but does not suffer from occlusions and is much more resilient to image noise.

For optical-flow based predictive visualization a round-trip delay between the MVTD and a remote client is calculated. In one embodiment, the round-trip delay is calculated by sending a test packet from the client to the MVTD that is immediately responded to with a reply packet, and duration for this transaction is recorded. An incoming image sequence is operated on by an optical flow scaling algorithm using techniques known in the art of computer vision. Using the assumption that the optical flow field remains constant from time T0 to time T2, the optical flow field is multiplied by a scaling constant equal to T2 divided by the time between successive frames used to compute the optical flow field, the resulting output representing the location of image pixels at time T2.

For image-centered based predictive visualization, a round-trip delay between the MVTD and a remote client is calculated. In one embodiment, the round-trip delay is calculated by sending a test packet from the client to the MVTD that is immediately responded to with a reply packet, and duration for this transaction is recorded. The center of mass of two successive images are determined, and an overall movement vector is derived from this computation. Using the assumption that the movement vector remains constant from time T0 to time T2, the vector is multiplied by a scaling constant equal to T2 divided by the time between successive frames used to compute the vector, the result representing the location of image pixels at time T2.

### Dead-Reckoning Correction

FIG. 4 is a diagram illustrating dead-reckoning correction functionality. MVTD movement is controlled by a differential drive system that tracks the movement of both wheels. Tracking a device's location based on sensed movement of the wheels is known as dead-reckoning, and is error prone: Often wheel slip, or floor surface properties causes an MVTD to move in a manner inconsistent with movement that would be predicted by the movement detected by the wheel sensors. Optical flow techniques, dominant motion techniques, block matching or integral projections can be used to compare the MVTD's actual location with the location predicted by wheel movement, and a feedback loop can compensate for any difference between the measurements. Techniques for accomplishing this, for example, visual odometry or visual servoing, are well known in the art of computer vision. This ensures that a user's movement command is accurately interpreted by the device.

In both cases, traditional techniques do not consider the issues that arise when the camera is intentionally moved while the MVTD's path is being corrected. Using traditional techniques, the algorithms cannot distinguish between intended movements of the camera (pan, tilt, or zoom) and errors due to wheel slip. By tracking the amount of pan, tilt, and zoom, using sensors external to the camera imaging system, and correcting for these movements, the camera can be moved by a remote operator while still properly correcting for dead-reckoning errors.

For example, an operator may tilt the camera down towards the ground while commanding the MVTD to move forward. Uncorrected, the tilt might be perceived as wheel slip, because the average optical flow vectors from forward motion would be partially canceled by the average optical flow vectors from tilting downwards. However, by subtracting an average optical flow vector equal to change induced by the tilt movement, the data fed to the movement control subsystem would remain correct.

This functionality can be implemented at either the client or the MVTD. User input 401 is translated to a commanded camera angle 402. Device movement 403 results in perceived movement by the camera, which is algorithmically extracted 404 using information about the current camera angle 402. Wheel rotation sensors sense the actual movement of the wheels 407. The movement perceived by the camera that can be attributed to floor movement is isolated using optical flow techniques, and knowledge of the height and angle of the camera. See path planning superposition, above, for more information on how the surface correlating with the floor can be calculated. Pixels correlating with the floor should move in a related fashion, dictated by the location of each pixel relative to the camera.

By normalizing the pixels through rotation so all pixels are viewed from a bird's-eye view, they all translate the same amount. Thus two rotated, normalized views of the floor can be compared for a relative pixel shift, which can be described as a horizontal translation 405, a vertical translation 406, and an in-plane rotation 411. Using information from the wheel rotation sensors, and knowledge of both the diameter of the wheels, and the distance between the wheels, a value equal to both the angle the wheel has been rotated 408, and a value equal to the distance the wheels have translated both horizontally and vertically 409 can be extracted. Thus it is possible to compare the motion of the MVTD device in its environment (its “ego-motion”) as detected by the camera and the wheel sensors 410. In situations where the camera data is believed to be robust (a clearly determined floor surface that moves in an internally-consistent manner is detected) it can be used to feed a new position command to the device movement subsystem 403, thereby providing corrective feedback to the wheel sensors.

### Advantages

What has been described is a new and improved method and apparatus for interactive robotic path planning, selection, and visualization.

By enabling an operator to select a motion path by forming a spline that is superimposed on the camera's image, a computationally inexpensive solution is created that allows the motion-path of the robot to be updated while the robot is still moving, resulting in a time-efficient movement scheme that does not suffer from the time lag effects of traditional joystick-based control.

By detecting obstacles, changing course in response to them, and displaying this altered course as a superimposed line on the image collected from the camera, the operator is freed from planning out complex move sequences while still allowing him to visualize and correct for improper automated path generation. Furthermore any operator error resulting from selecting a path that nearly intersects or intersects an obstruction is gracefully corrected while the operator is simultaneously informed of his mistake by the displayed course correction.

Predictive visualization allows the operator to plan new move sequences on-the-fly based on a simulation of the current conditions the robot is encountering. Therefore the operator can respond more quickly and can move the device at a higher velocity, resulting in more efficient tele-operation.

Dead-reckoning correction allows an operator to pan and tilt the device's camera while course correction is occurring and without impacting the accuracy of the movement path correction, thereby allowing the same camera to be used to dynamically view the environment while still maintaining an accurate course as selected by the operator.

Path suggestion simplifies the selection of paths through the environment, thereby making device navigation quicker and more user-friendly.

While certain exemplary embodiments have been described in detail and shown in the accompanying drawings, it is to be understood that such embodiments are merely illustrative of and not restrictive on the broad invention, and that this invention is not to be limited to the specific arrangements and constructions shown and described, since various other modifications may occur to those with ordinary skill in the art.

What is claimed:

1. A method of controlling a remotely located robot comprising the steps of:
a) computationally superimposing a graphical representation of a path on an image of a remote location, the image displayed on a computer display;
b) computationally modifying the graphical representation of the path in response to a user input; and
c) computationally executing a move sequence derived from the graphical representation of the modified path.

2. The method of claim 1, wherein:
the remotely located robot adjusts its path due to user input while it is moving.

3. The method of claim 1, wherein:
a section of the move sequence has a curvature of a clothoid spiral.

4. The method of claim 1, wherein:
subsequent move sequences are continuously and automatically executing by the robot at a predefined rate.

5. A method of avoiding an obstacle comprising the steps of:
a) computationally superimposing a line or curve on an image of a remote location, the image displayed on a computer display;
b) detecting the distance of an object by use of a distance sensor;
c) moving in response to the detected object; and
d) superimposing a second line or second curve on an image of a remote location, the image displayed on a computer screen, where the second line or second curve represents the movement in response to the detected object.

6. A method of avoiding an obstacle comprising the steps of:
a) computationally superimposing a line or curve on an image of a remote location, the image displayed on a computer display;
b) detecting the distance of an object by use of a distance sensor;
c) superimposing a second line or second curve on an image of a remote location, the image displayed on a computer screen, where the second line or second curve represents the planned movement in response to the detected object; and
d) moving in accordance with the planned movement.

7. A method of controlling a remotely located robot comprising the steps of:
a) determining the round-trip delay for information sent between a client and a remotely located robot;
b) accepting an image of a remote location from a remotely located robot;
c) modifying the image such that it is representative of a predicted movement of the robot, the predicted movement predicted to occur at a time equal to the round-trip delay;
d) displaying the modified image

8. A method of controlling a remotely located robot comprising the steps of
a) accepting a camera image;
b) normalizing the camera image whereby the normalized camera image is invariant with respect to a camera angle;
c) deriving a first horizontal translation, a first vertical translation, and a first in-plane rotation from the normalized camera image;
d) deriving a second horizontal translation, a second vertical translation, and a second in-plane rotation from a plurality of wheel rotation sensors;
e) determining an error in robot position by measuring the difference between the first horizontal translation and the second horizontal translation, the first vertical translation and the second vertical translation, and the first in-plane rotation and the second in-plane rotation; and
f) moving a wheel rotation motor in a corrective manner based on the error in robot position.

9. A method of controlling a remotely located robot comprising the steps of:
a) accepting a one-dimensional array of distance values from a distance sensor;
b) finding a local maxima in the one-dimensional array of distance values;
c) plotting a path from the current location of the remotely located robot to a location represented by the local maxima in the one-dimensional array of distance values; and
d) displaying the path on a graphical user interface;

10. Mobile video teleconferencing system and control method An apparatus for controlling a remotely located robot comprising:
a) a distance sensor;
b) a computer accepting a one-dimensional array of distance values from the distance sensor, the computer finding a local maxima in the one-dimensional array of values, and calculating a path from a current location of the remotely located robot to a location represented by the local maxima; and
c) a display showing a graphical representation of the calculated path.
